(19) United States
(12) Patent Application Publication
(10) Pub. No.: US 2006/0241523 A1
(43) Pub. Date: Oct. 26, 2006

(54) Ultrasound generating method, apparatus and probe

(75) Inventors: Yegor Sinelnikov, Port Jefferson, NY (US); Reinhard Warnking, Setauket, NY (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: ProRhythm, Inc., Ronkonkoma, NY (US)

(21) Appl. No.: 11/103,825

(22) Filed: Apr. 12, 2005

(51) Int. Cl. A61H 1/00

(52) U.S. Cl. 601/2; 600/439

(57) ABSTRACT

Ultrasound energy originating from an emitter at a number of predetermined positions is sensed by a plurality of duplex transducers in a predefined arrangement. Each transducer produces a sensor signal representing ultrasound energy sensed by it, and the sensor signals of each transducer are stored in association with the predetermined position producing the sensor signal. Thereafter, an ablation pattern corresponding to a group of the predetermined positions may be generated by actuating each transducer with a time-reversed version of the sensor signals stored in association with the group of positions. By placing the transducers in a predetermined spatial relationship to the heart, the ablation pattern may be formed on the ostium of a pulmonary artery. Preferably the predetermined positions correspond to a grid of dots that may be used to approximate virtually any shape.

### BACKGROUND OF THE INVENTION

The present invention relates to a high intensity ultrasound ablation apparatus and probe, and a method utilizing the principle of time-reversed acoustics. Known for years, high intensity focused ultrasound (HIFU) recently became an effective and widespread medical therapy technique. An expected benefit of HIFU is the creation of a clinical effect in a desired, confined location within a body, without damage to intervening tissue.

A broad and diverse range of HIFU therapies, from shock wave lithotripsy, ultrasound enhanced drug deliveries, immune response stimulation, to hemostasis, non-invasive surgery is now in use¹. In HIFU therapy the acoustic field is focused to a target area. Absorption of high intensity ultrasound in a focal region causes a significant temperature rise, resulting in coagulative necrosis of the target tissue. The irreversible ablation within the focal zone is defined by ultrasound source geometry.
¹ M. R. Bailey et al, 2003, “Physical Mechanisms of The Therapeutic Effect of Ultrasound”, Acoustical Physics, 49, 4, pp 369-388.

In HIFU therapy, it is important to create only target tissue ablation, without damage to other tissue. In certain applications, geometrical focusing of ultrasound to a target is not possible. While current ablation devices and methods produce an ablation pattern which is primarily device dependent, in complex anatomy, an ablation away from a device dependent focal zone is often necessary. It would therefore be desirable for an ablation method and apparatus to be able to create lesions of variable configuration which are independent of device geometry.

The time reversal principles of ultrasonic wave propagation were first described by Fink, M., 1997, “Time Reversed Acoustics”, Physics Today, March 1997, pp 34-40, which is incorporated herein by reference. Within the range of ultrasonic frequencies, where the adiabatic processes dominate, the acoustic pressure wave propagation equation is time-reversal invariant. This means that for a burst of ultrasound originating from a point in space and later possibly being reflected, refracted or scattered while propagating through the medium toward the catheter, transducer(s) output signals that precisely retrace the propagation path will converge back toward the initial point in space.

Contraction or “beating” of the heart is controlled by electrical impulses generated at nodes within the heart and transmitted along conductive pathways extending within the wall of the heart. Certain diseases of the heart known as cardiac arrhythmias, such as atrial fibrillation, involve abnormal generation or conduction of the electrical impulses. The abnormal conduction routes in atrial fibrillation typically extend from the wall of the heart and along the pulmonary veins of the left atrium. After unwanted electrical impulses are generated in the pulmonary veins or conducted through the pulmonary veins from other sources, they are conducted into the left atrium where they can initiate or continue atrial fibrillation. By deliberately damaging or “ablating” the tissue of the cardiac wall to form a scar along a path crossing the route of abnormal conduction, propagation of unwanted electrical signals from one portion of the heart to another can be blocked.

As described in Fjield et al. U.S. Pat. No. 6,635,054, and in International Publication WO 2004/073505, the disclosures of which are incorporated herein by reference, atrial fibrillation can be treated by ablating tissue in an annular pattern around a pulmonary vein at or around the ostium, the juncture between the pulmonary vein and the heart. As disclosed therein, ablation is performed by making use of high intensity focused ultra-sound. A catheter is introduced into the interior space of the left atrium. The catheter includes a balloon containing an ultrasound reflector collapsed around a cylindrical ultrasound-emitting transducer. When the balloon is inflated, the reflector assumes a shape that focuses the ultrasonic energy emitted by the transducer in a ring-like pattern on the cardiac tissue at the ostium, producing an annular scar.

Although the Fjield system produces a scar at the desired location, the size and shape of the ultrasound pattern is determined by the configuration of the reflector. This limits to some degree the size and shape of the scar that can be produced and the ability of the physician to adapt the treatment to variations in the anatomy of patients. In many cases, for example, to avoid phrenic nerve damage, physicians may need to exclude a certain region from application of ultrasound. Also, variability in ostium size requires catheter exchanges. Thus, flexibility with respect to the lesion shape and size produced by an ablation method and apparatus would be desirable to address varying anatomical situations.

Another technique for performing cardiac ablation is disclosed in Govari et al. U.S. Patent Application Publication No. 2004/0162550. An unfocused ultrasound emitter (a “beacon”) is introduced to a target site inside the heart through a catheter. Several duplex (emitter and detector) ultrasound transducers are placed outside the body in the vicinity of the heart, and the beacon is activated. The ultrasound originating from the beacon is sensed by the external duplex transducers, and the signals they produce are reversed in time, and each such signal is used to drive the respective transducer into emission. As disclosed in Fink U.S. Pat. No. 5,431,053, the ultrasound signals produced by the external duplex transducers will combine to produce a focused spot of ultrasound energy at the site of the beacon. By moving around the beacon and repeating the sensing/emitting operation of the external duplex transducers, it becomes possible to produce an ablation in any desired pattern. Although it is possible for a surgeon to produce any desired shape of scar by moving around the beacon, this is a very demanding and cumbersome process.

### SUMMARY OF THE INVENTION

In accordance with one aspect of the present invention, ultrasonic transducers in a predefined arrangement are maintained in ultrasonic communication with the body and are operated using actuating signals derived from pre-existing, stored representations of sensor signals which would be detected by the transducers in response to ultrasound energy, such as a brief ultrasonic impulse, originating from an emitter at a number of predetermined points constituting a pattern. The actuating signals most preferably constitute a time-reversed replica of the sensor signals, so that the ultrasonic signal emitted by the transducers substantially recreates the original ultrasonic signal at the points constituting the pattern. By placing the transducers in a predetermined spatial relationship, the ablation pattern may be formed in a desired location. For example, by placing the transducers in a predetermined relative relationship and a predetermined relationship to the heart, the ablation pattern may be formed around the ostium of a pulmonary artery.

In one embodiment, the stored representations may be derived by placing a reference source and the ultrasonic transducers, while in their predefined arrangement, in a medium having ultrasonic properties approximating that of the environment in which ablation is to be performed. The reference source is actuated to emit ultrasonic energy from a point on a pattern. Each transducer produces a sensor signal representing ultrasound energy sensed by it, and the sensor signals of the various transducers, or time-reversed versions of the sensor signals, are stored in association with the location of the point. This process is replicated for other points producing corresponding sensor signals.

Because the representations of the sensor signals are available before the transducers are placed on or in the body, there is no need to place a beacon within the body where ablation is desired, and no need to trace the pattern to be ablated by moving such a beacon within the body.

Representations of sensor signals can be obtained for numerous points in a two-dimensional or three-dimensional grid, with each point defined in the frame of reference of the transducers, so as to provide a group of stored representations, each associated with a grid point in the frame of reference of the transducers. Such a group of stored representations may be used to form a pattern approximating virtually any shape within the range encompassed by the grid.

In accordance with another aspect of the invention, a catheter to be introduced into the interior space of the left atrium includes a distal balloon containing an ultrasound reflector collapsed around a transducer assembly containing a plurality of duplex transducers. When the balloon is inflated, the reflector assumes a shape that reflects distally any ultrasonic energy emitted by the transducers.

### BRIEF DESCRIPTION OF THE DRAWINGS

The foregoing brief description, as well as further objects, features and advantages of the present invention will be understood more completely from the following detailed description of certain embodiments, with a reference being had to the accompanying drawings, in which:

FIG. 1 is a schematic representation of a probe according to one embodiment of the present invention;

FIG. 2 a schematic representation of a transducer assembly included in the probe of FIG. 1;

FIG. 3 is a schematic diagram useful in explaining certain principles of time reversed acoustics;

FIG. 4 is a functional block diagram illustrating an apparatus for performing ultrasonic ablation in accordance with one embodiment of the present invention.

### DETAILED DESCRIPTION

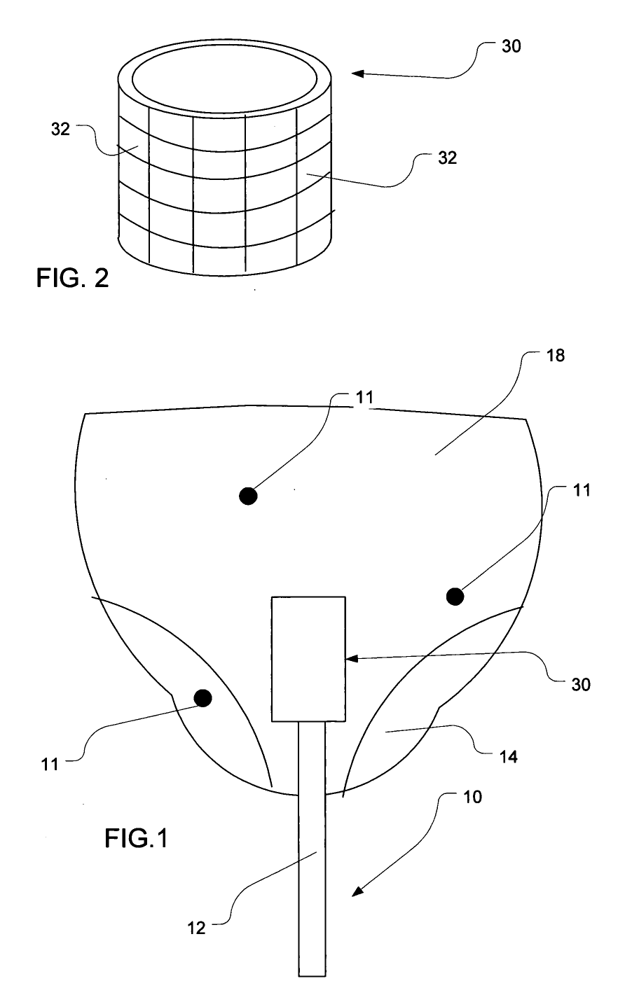

Turning now to the details of the drawings, FIG. 1 is a schematic representation of an embodiment of a probe in accordance with the present invention. A probe 10 includes a catheter 12 having a distal end bearing an outer, reflector balloon 14; an inner, structural balloon 18; and a transducer subassembly 30. U.S. Pat. No. 6,635,054 and International Publication WO 2004/073505, discussed above, disclose in more detail various probe structures of this type. Such disclosure is incorporated herein by reference.

Prior to use, the probe would be in a collapsed state, in which both balloons are collapsed about the transducer subassembly 30. Preferably, this probe is for use in cardiac ablation. Accordingly, it could be inserted over a guide wire, through a sheath which, in accordance with conventional practice, has previously been threaded through a patient's circulatory system and into the left atrium of the heart. However, there are other known techniques for positioning the probe, including surgical procedures.

Following that, the structural balloon 18 may be inflated by injecting through a lumen of the catheter 12 a liquid, such as saline solution, which has an ultrasonic impedance approximating that of blood. The reflector balloon 14 is inflated by injecting through another lumen of catheter 12 a gas, such as carbon dioxide. Owing to the different ultrasound impedance of the two inflation media, the interface between balloons 14 and 18 would then reflect ultrasound waves forward, through the distal portion of the balloon 18.

Probe 10 also includes one or more position-determining elements 11 which lie in a predetermined spatial relationship to the transducer assembly 30. These position-determining elements are arranged so that the disposition of the position-determining elements, and hence the disposition of the transducer assembly including its position and orientation, can be detected during use of the probe. In FIG. 1, these are depicted as a set of three point markers such as radio-opaque markers which can be visualized using X-ray or fluoroscopic imaging. Other point markers suitable for magnetic resonance imaging may be used.

Alternatively or additionally, the position-determining elements may include magnetic or electromagnetic transducers which can interact with external magnetic or electromagnetic transducers to determine the position or orientation of a probe in the frame of reference of these external devices. Such transducer systems are well known in the art.

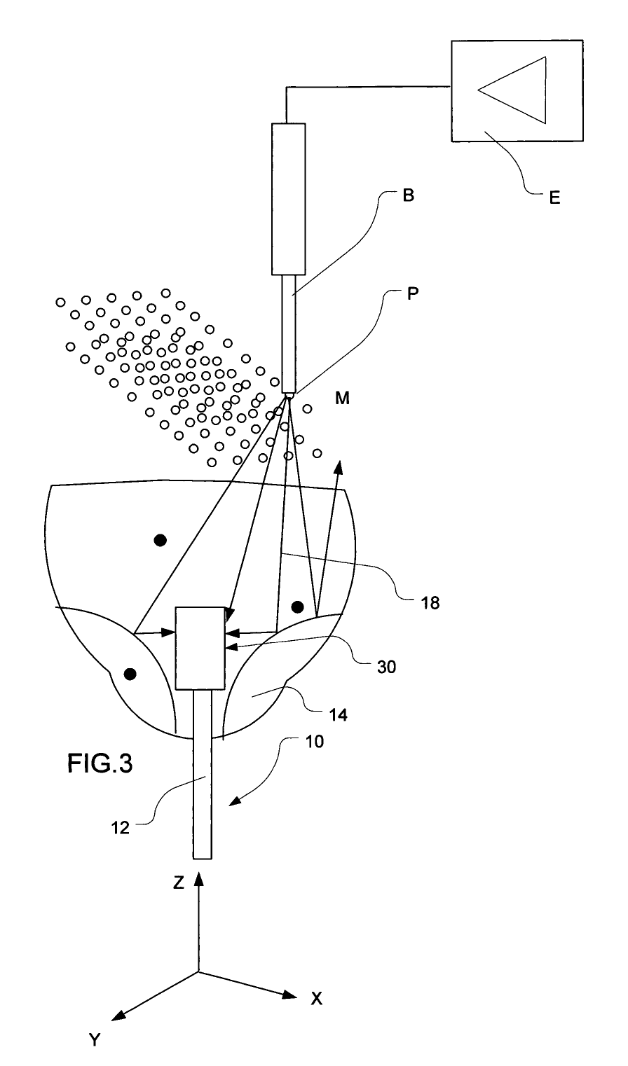

FIG. 2 is a schematic representation of the transducer assembly 30. In this embodiment, it is cylindrically shaped and is made up of a plurality of ultrasound transducers 32 which cover its surface. The individual transducers 32 may be physically separate elements or may be formed as a unitary body of piezoelectric material, such as the hollow tubular body depicted in FIG. 3, with individual ground or signal electrodes covering different portions of the unitary body so that each portion acts partially or completely independently of the other portions and hence constitutes a separate transducer. The assembly may be virtually any other shape.

When exposed to ultrasonic energy, each of the transducers 32 independently senses ultrasonic energy incident upon it, producing a time varying signal on conductors (not shown) within probe 10 associated with that transducer. That sensor signal represents the ultrasound impinging on the individual transducers. Each of the transducers will also emit ultrasound energy when actuated by an electrical signal provided via the same conductors carried.

FIG. 3 is a schematic diagram useful in explaining the principle of time reversed acoustics as it applies to the present invention. The probe 10, with the balloons 14 and 18 inflated as discussed above, and a reference ultrasound source such as an emitter or beacon B are both present in a medium M. Medium M desirably has acoustic properties, such as acoustic velocity and acoustic impedance, simulating the acoustic properties of the environment in which the balloons and transducer assembly will be placed when performing ablation. For example, where the balloons and transducer assembly will be disposed within the heart of the body, the medium may be water to simulate the acoustic properties of blood. In the particular embodiment shown, the medium has uniform and substantially isotropic acoustic properties.

The beacon is disposed at a point P within the frame of reference of the transducer assembly and balloons. This frame of reference is schematically indicated by Cartesian coordinates x,y,z in FIG. 3. Any other coordinate system, such as polar or cylindrical coordinates, may be used. The beacon is actuated by an electrical signal source E, desirably with a signal approximating an impulse. The beacon produces ultrasound energy which travels in all directions.

Ultrasound entering the structural balloon 18 will either impinge directly upon transducer assembly 30, or it will be reflected one or more times from the interface between the two balloons and either exit the probe or impinge upon the transducer subassembly 30. The ultrasound energy impinging upon the transducer subassembly 30 will be sensed by one or more of the transducers 32, which will each produce a time-varying electrical sensor signal component representing the ultrasound energy it senses. If these sensor signal components were reversed in time and used to actuate their respective sensors, the signals thus produced would cooperatively reproduce at point P the signal originally produced at point P by the beacon B.

A representation of the plural signal components is stored in a storage device 55 in any convenient form and associated with the particular point P. For example, each component may be stored as an analog or digital record of the component as originally received, or as a corresponding record of the same signal with the time scale reversed. A digital record may include a series of values each representing a sample of the component waveform at a particular time. Such a series may be read out of storage in the original order, or may be read out in reverse order to provide a time-reversed representation. Each record may represent a set of signals to create an impact in a single discrete grid point, combination of points, or solid volume of predefined shape.

The same process is repeated with beacon B at a plurality of points 115 constituting a two-dimensional or, more preferably, three-dimensional grid of points, so that a representation of the sensor signals is stored for each of the plural points, each such representation being associated with a particular point defined in the frame of reference of the transducer assembly. The grid of points need not be a rectilinear grid; it may include concentric circular arrays of points, or points at irregularly spaced locations.

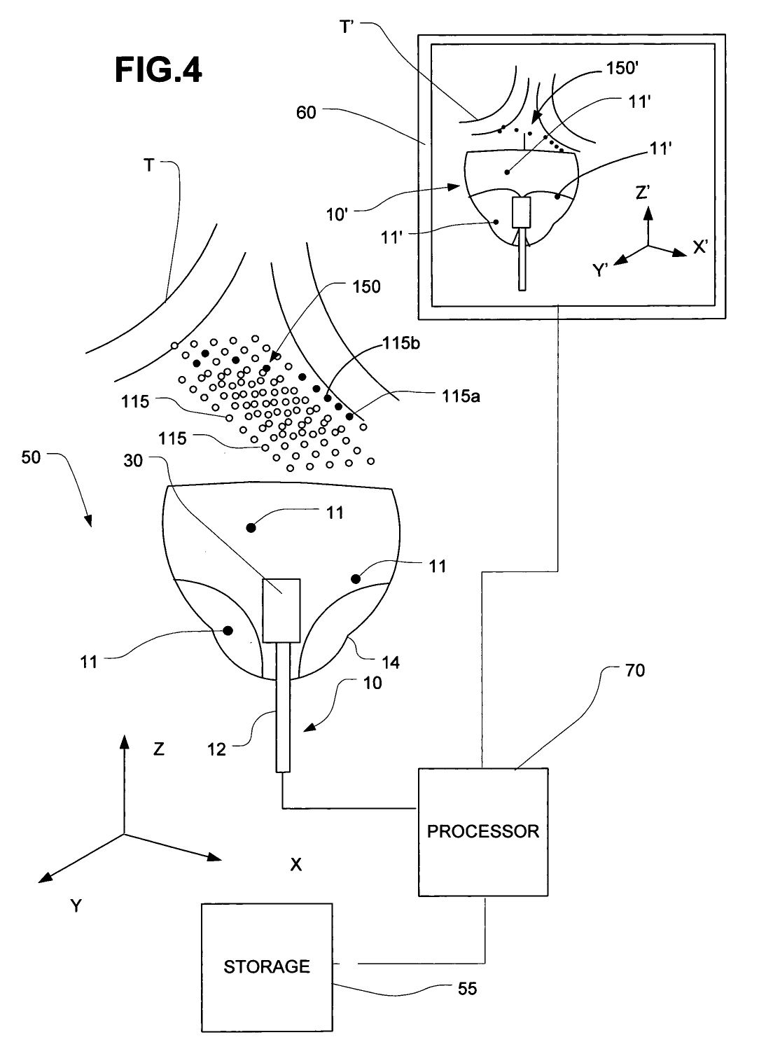

FIG. 4 is a functional block diagram illustrating the operation of a preferred apparatus 50 incorporating probe 10 to perform ultrasound ablation. Apparatus 50 includes a probe 10 of the type already described, a storage unit 55 holding the representations of sensor signals as discussed above, a display 60, and a processor 70. Processor 70 may include the elements of a conventional general-purpose digital computer, and may also include digital-to-analog conversion circuitry and amplification circuitry for providing actuation signals as discussed below. Prior to and during treatment, the patient's heart and the probe 10 may be observed through a fluoroscope, a CAT, or any other conventional imaging device, with the image being displayed on display 60. This permits the surgeon to plan how ablation will be performed. With probe 10 positioned within the heart as explained above, the surgeon can assure the rotational position of the probe by bringing index marks 11 to a reference position relative to the structures of the patient's body, at or near the prospective location of an ablation, so that the ultrasonic transducer assembly is in ultrasonic communication with tissues at such location.

The operator may then select the shape, size and rotational orientation of the desired ablation pattern, in the frame of reference of the probe, such as by selecting from a menu of standard patterns stored in processor 70 or in storage unit 55.

The operator may also draw a pattern with a light pen or a mouse superimposed on the image displayed on screen 60. An internal calculation will then determine the best fit between selected pattern and stored ablation points. This is of particular importance in certain anatomical situations were cavities or vessels are in close vicinity leaving only a small tissue ridge to be ablated. An example is the left pulmonary veins and the left atrial appendage lying closely together leaving only a small tissue ridge between them.

Such selection may be based upon knowledge of the position of the probe and transducer assembly relative to the body tissues to be ablated. For example, if the probe is positioned so that the distal face of balloon 18 confronts a wall of the heart with the axis of the transducer assembly and probe aligned with the axis of a pulmonary vein, the physician may select a stored pattern in the form of a ring or loop of specified diameter encircling the axis in a plane just distal to such distal face.

Once the desired ablation pattern has been selected, processor 70 identifies those points 115a from among the grid points 115, in the frame of reference of the probe, which constitute the pattern. The processor then selects a stored signal representation from storage unit 55 associated with a first identified one of the points 115a, and generates actuation signals based on the stored signal representation corresponding to a time-reversed replica of the sensor signals which were produced by the various transducers in response to ultrasound emitted from that point. For example, if the stored signal representations include series of digital samples of the originally-received sensor signals, the processor may simply read out the samples constituting the signal component for each transducer in reverse order and convert the resulting digital signal to analog form to create an actuation signal component for the corresponding transducer. The processor applies the actuation signal components simultaneously to all of the transducers. The resulting ultrasonic emissions from the transducer assembly create a replica of the ultrasonic impulse at the point, and thus cause micro cavitation at such point. The same process is then repeated for the other points in the pattern.

The application of time reversed signals can be combined with a standard ultrasound therapy procedure that can be executed by the same transducers. The effect of micro caviation will enhance ultrasound absorption and tissue impact at the site of time reversed signal convergence. Continuous ultrasound signal can be delivered following a single or a series of time reversed impulses.

Signals can be obtained in a laboratory setting to create time reversed signals that would affect a volume of tissue rather than discrete points. A collection of applicable shape transducers can be used to generate the reference signal, which is sensed by all probe transducers and reversed in time and recorded. Subsequently, the probe transducers can be actuated with respective recorded signals, to create a simultaneous tissue impact at a volume of tissue directly corresponding to shape transducers. A cavitation cloud can be generate this way substantially simultaneously over a volume of the tissue, and it can be controlled by repetitive application of the same set of signals.

It also can be combined with continuous wave ultrasound delivery between time reversed pulses to enhance ultrasound absorption due to cavitation and to keep caviational bubbles from collapsing. Also, the actuation signals associated with each point or volume may be applied repeatedly with varying amplitude parameters.

In a further variant, the stored representations may include only representations associated with points constituting a single pattern as, for example, a ring of a particular diameter at a particular location in the frame of reference of the probe and transducer assembly. In this case, the physician maneuvers the probe to a predetermined position to properly align the pattern with the body tissues, and then instructs the processor to begin ablation. The processor forms and applies the actuation signals corresponding to each of the stored representations.

In yet a further variant, the processor determines the disposition of the probe, and hence the transducer assembly, relative to the body of the patient and specifies the points constituting a pattern so that the pattern lies in the desired location within the patient's body. As shown in FIG. 4, the data constituting an image of the relevant portion of the patient (the tissues T of the heart wall) is supplied to the processor and the processor generates an image on display 60 representing this portion of the patient in an image frame of reference. The processor is also supplied with data specifying the disposition of the probe in the image frame of reference. For example, using conventional input devices (not shown) connected to processor 70, the physician may move a cursor on display 60 into alignment with the image 11′ of each of the spot markers 11 on probe 10, and inputs a signal to the processor when such alignment is achieved. Repeating this process using images in two orthogonal planes completely specifies the location of the spot markers in the image frame of reference.

Inasmuch as the locations of these markers in the frame of reference of the probe is known, this fully specifies the disposition of the probe in the image frame of reference, and provides all of the information necessary to derive a geometric transformation between the image frame of reference (and hence the frame of reference of the patient's body) and the frame of reference of the probe.

In a system where the position-determining elements of the probe include magnetic or electromagnetic transducers, the information specifying the disposition of the probe may be acquired in a frame of reference associated with the transducers, and transformed into the image frame of reference using data relating the transducer frame of reference to the image frame of reference.

The physician may specify the desired ablation pattern directly in image frame of reference by drawing the desired pattern on the screen, using conventional computer input devices. For example, the screen may be a touch-sensitive screen. Computer techniques for selecting and drawing shapes are well known in the art. The desired pattern is then transformed into the frame of reference of the probe. Processor 70 is then operated to select those points which lie on the desired pattern. For example, in FIG. 4, the desired pattern has been traced as a curve 150′ in the image frame of reference X′Y′Z′ on display 60′. This curve is transformed into a theoretical curve 150 in the XYZ frame of reference of the probe 10. Points 115a, 115b and the other points 115 shown in solid black lie on this curve, or in close proximity to it. The processor 70 selects these points as the points constituting the pattern. In the same manner as discussed above, the processor 70 creates a set of actuation signals for transducer assembly 30 that will produce the ablation pattern.

In a variant of this approach, the step of determining the disposition of the probe relative to the patient's body may be repeated during the step of applying the actuation signals. For example, the determining step may be repeated after each point is treated. If the disposition changes, the transformation between the frame of reference of the body and the frame of reference of the probe will also change, and processor 70 therefore will select a new set of points constituting the untreated portions of the desired pattern. This avoids the need to hold the probe at a constant location relative to the patient's body during the entire ablation step and compensates for cardiac motion or breathing artifacts.

Memory storage element 55 is depicted as an element separate from processor 70 and separate from probe 10. However, if probe 10 is the only probe specified for use with the processor, the information may be contained in a ROM (read only memory) chip or other element of the processor. Alternately, the processor may be designed for use with different probes and, during setup, the probe being used is specified, automatically designating a special section of storage to be accessed for the transducer drive signal information.

In a further variant, a physical element such as a semiconductor chip or other data storage medium 55 may be incorporated in probe 10 or supplied with the probe in a kit. In a further variant, the storage element may be at a remote location accessible to processor 70 via the Internet or other communications link. For example, the probe manufacturer may maintain sets of stored signal representations appropriate for various probes.

In any case, the processor will have access to storage containing the necessary information to generate a set of actuation signals that will drive the transducers of the probe so to produce the patterns discussed above.

In the signal representation storing process as described above with reference to FIG. 3, the same probe 10 and transducer assembly 30 which is used to perform the ablation is also used to acquire the sensor signals. However, this is not essential. A different probe and transducer assembly referred to herein as a “model” of the transducer assembly used for ablation, can be used, provided that the model accurately reflects the characteristics such as signal response of the actual transducer assembly used to perform the ablation. In this case, it would never be necessary to use the transducers 32 of the transducer assembly 30 used for the ablation as ultrasound sensors. These transducers serve only as ultrasound emitters. Where numerous probes and transducer assemblies are mass-produced, one such device can serve as a model, and the others can be used for ablation.

It will be appreciated that the use of the invention for cardiac ablation is merely an exemplary application, as the invention should find broad application in surgical and non-surgical treatments.

It is not essential to provide a reflector associated with the transducer unit. Also, the probe and other aspects of the invention are not limited to use inside a living body. For example a probe could be positioned outside the body so as to inject ultrasound energy to a specific location within the body, for example to perform ablation, provide localized heating or destroy a kidney stone.

Although a preferred embodiment of the invention has been disclosed for illustrative purposes, those skilled in the art will appreciate that many additions, modifications and substitutions are possible without departing from the scope and spirit of the invention as defined by the accompanying claims.

What is claimed:

1. A method for generating a pattern of ultrasound energy useful for performing ablation of body tissue, comprising the steps of:
maintaining a set of ultrasound transducers in predefined locations relative to one another and in ultrasonic communication with the body;
applying a set of actuating signals to the transducers, the actuating signals corresponding to a time-reversed version of sensor signals representing the ultrasound signals that would be detected by the transducers while in their predefined locations if an ultrasound emitter were placed in a set of positions defining the pattern, the actuating signals being constituted so that the pattern is at least two-dimensional, said applying step being performed using representations of the sensor signals available prior to the maintaining step.

2. The method of claim 1 wherein the representations of the sensor signals are obtained by placing a reference source and the transducers in a reference medium emulating the ultrasound response of a living body.

3. The method of claim 1 further comprising, prior to the applying step, positioning the ultrasound transducers so that the pattern will coincide with a selected area of body tissue.

4. The method of claim 3 wherein the body tissue is within a living body.

5. The method of claim 3 wherein the tissue is cardiac tissue.

6. The method of claim 3 wherein said positioning step includes positioning relative to the body a probe carrying said transducers.

7. The method of claim 1 wherein the applying step further comprises:
(a) providing a set of stored signals associated with a grid of points in a frame of reference defined by said transducers, each said stored signal corresponding to (i) sensor signals representing ultrasound signals that would be detected by the transducers if an ultrasound emitter were placed at a point associated with such stored signal or (ii) a time reversal of (i); and
(b) selecting for application to the transducers only those of the stored signals associated with points lying on the pattern.

8. The method of claim 7 wherein the stored sensor signals are obtained by placing a reference source and the transducers in a reference medium emulating the ultrasound response of a living body and actuating said reference source to emit ultrasonic energy from each of said points.

9. The method of claim 7 wherein the stored sensor signals are obtained by placing a reference source and a model having receivers at said predefined locations in a reference medium emulating the ultrasound response of a living body and actuating said reference source to emit ultrasonic energy from points in the frame of reference of said model corresponding to said points in said frame of reference of said transducers.

10. The method of claim 7 further comprising, prior to the applying step, positioning the ultrasound transducers so that the predetermined area will coincide with a selected area of body tissue.

11. The method of claim 7 further comprising the step of determining the disposition of the frame of reference of the transducers relative to the body and selecting said points so that said pattern will coincide with a selected area of body tissue.

12. The method of claim 11 wherein said determining and selecting steps are performed repeatedly during said applying step.

13. The method of claim 10 wherein the body tissue is within a living body.

14. The method of claim 10 wherein the tissue is cardiac tissue.

15. An apparatus for generating a pattern of ultrasound energy useful for performing ablation of body tissue with the ultrasound energy, comprising:
a set of ultrasound emitters arranged in predefined locations relative to the predetermined area;
a source of a first plurality of pre-existing representations of sensor signals that would be sensed by ultrasound receivers collocated with the ultrasound emitters if a further ultrasound emitter were placed in a group of positions defining the pattern in the area; and
an actuator for driving said emitters in response to said pre-existing representations with actuating signals corresponding to time reversals of said sensor signals.

16. The apparatus of claim 15 wherein the ultrasound emitters are mounted on a probe and the probe includes an indicium spatially related to the position at which the pattern will be produced and its orientation.

17. The apparatus of claim 15 wherein the actuating signals correspond to time reversed versions of signals that would be obtained by placing a reference source and the transducers in a reference medium emulating the ultrasound response of a living body.

18. The apparatus of claim 15, wherein said source further comprising a storage device for holding a set of stored representations associated with a grid of points in a frame of reference defined by said transducers, each said stored representation corresponding to (i) sensor signals representing ultrasound signals that would be detected by the transducers if an ultrasound emitter were placed at a point associated with such stored signal or (ii) a time reversal of (i); and a selector enabling application to the transducers of only those stored representations from the storage device associated with points lying on the pattern.

19. The apparatus of claim 15 wherein the ultrasound transducers are mounted on a probe and the probe includes a reflector for ultrasound signals from the emitters.

20. The apparatus of claim 19 wherein the ultrasound emitters are mounted in a substantially cylindrical pattern about an axis and the reflector is substantially coaxial with the axis and includes a reflective surface in opposed relationship to the emitters.

21. An ultrasound probe comprising a plurality of ultrasound emitters mounted in a pattern so as to emit in different directions and a reflector of ultrasound energy which includes an ultrasound reflective surface in opposed relation ship to the transducers.

22. The probe of claim 21 wherein the emitters are mounted so as to emit in a substantially cylindrical pattern.

23. The probe of claim 22 wherein the reflective surface is substantially concentric with the axis of the cylindrical pattern.
